(19) United States
(12) Patent Application Publication
(10) Pub. No.: US 2011/0033255 A1
(43) Pub. Date: Feb. 10, 2011

(54) Gun Drill

(75) Inventor: Takuji Nomura, Hyogo (JP)

Correspondence Address: WOMBLE CARLYLE SANDRIDGE & RICE, PLLC, ATTN: IP DOCKETING, P.O. BOX 7037, ATLANTA, GA, 30357-0037, US

(73) Assignee: Unitac, Inc., Amagasaki-shi (JP)

(21) Appl. No.: 12/888,586

(22) Filed: Sep. 23, 2010

Related U.S. Application Data
(63) Continuation-in-part of application No. PCT/JP2008/070907, filed on Nov. 18, 2008.

(30) Foreign Application Priority Data
Mar. 25, 2008 (JP) JP2008-077207

(51) Int. Cl. B23B 41/02; B23B 51/02; B23B 51/06; B23B 35/00

(52) U.S. Cl. 408/1 R; 408/59; 408/80; 408/204

(57) ABSTRACT

A gun drill has a cutting blade which attains high cutting efficiency without requiring exact positional accuracy at the time of brazing an associated cutting blade tip onto a cutting head. Thus, the cutting head can be manufactured easily and the cutting blade itself is also easily processed. The cutting blade is configured such that an inner end of a blade edge is spaced apart from a head central axis to form a non-cutting zone in the vicinity of the shaft center, a cutting blade side face at the inner end side constitutes an inclined surface which is inclined from the inner end to the head central axis side, and a uncut core of a work material generated in the non-cutting zone is broken off by press-contact of the inclined cutting blade side face during drilling operations.

### RELATED APPLICATIONS

This is a continuation-in-part of international application no. PCT/JP2008/070907, filed 18 Nov. 2008, which published as WO 2009/118947A1 and claims priority to JP2008-077207, filed 25 Mar. 2008. The contents of the aforementioned applications are incorporated by reference in their entirety.

### TECHNICAL FIELD

The present invention relates to a gun drill used for deep-hole drilling work.

### BACKGROUND ART

As a deep-hole drilling work system, various systems such as a gun drill system, an ejector system (double tube system), a single tube system, etc., have been known, and the gun drill system is suitable for deep-hole drilling work of a small diameter. More specifically, as shown, for example, in FIG. 6 and FIG. 7, the gun drill system generally adopts a gun drill having a cutting head 72 which is provided at a distal end of a hollow tool shank 71 of a two-thirds to three-quarters circle in cross section and has the same cross-sectional outline. The gun drill carries out cutting while supplying a coolant, which is supplied through coolant supply passages 73a, 73b within the tool shank 71 and cutting head 72, from coolant discharge ports 74 at a distal end surface of the head to a cutting region, and also discharges cutting chips, which are generated in line with the cutting, to the exterior together with the coolant through a cross-sectionally V-shaped cutting chip discharge groove 75 extending along the lengthwise direction of an outer circumference of the tool shank 71. In addition to that a large passage cross-sectional area of the cutting chip discharge groove 75 can be secured even with a small diameter, a coolant feed pressure is determined by a tool length and there is no need to increase the feed pressure even when a cutting hole becomes deep. Accordingly, the gun drill system is suitable for deep-hole drilling work of a small diameter, such as disclosed in Japanese Published Unexamined Patent Application No. 2004-130413. In FIG. 6 and FIG. 7, reference numeral 76 denotes a cutting blade tip bordering, brazed to and fixed with the cutting chip discharge groove 75 at the distal end portion of the cutting head 72, reference numeral 77 denotes a guide pad brazed to and fixed with a distal end side of an outer circumferential portion away from the cutting chip discharge groove 75 of the cutting head 72, and reference numeral 78 denotes a large-diameter cylindrical driver into which a proximal end portion of the tool shank 71 is inserted, fitted and fixed.

In order to cut and form the whole of a cutting hole in deep-hole drilling work including this gun drill system, a center side cutting blade (cutting blade itself in the case of a single-edged blade) of the cutting head is required to be configured precisely such that a blade edge matches with a radial line about a head central axis and also an inner end of the blade edge is arranged slightly beyond the head central axis. Therefore, a cutting speed becomes zero theoretically at the head central axis during drilling operations, and thus, a blade point portion positioned in the head central axis does not exert a cutting force at what is called a chisel edge, which results in crushing a work material, and thrust resistance is loaded. As a result, this has been a factor that cutting efficiency cannot be enhanced. Further, in a gun drill configured such that a cutting blade tip is brazed to a recessed portion of a head main body side, a brazing material intervenes at a fitting portion of the both, so that high precision assembly has been difficult.

Consequently, as for a deep-hole drilling work tool employing a screw clamping type throw away tip as a cutting blade, the present inventor has already proposed one configured such that a sinking portion is provided to a tip side face at a cutting blade inner end side, and the cutting blade inner end is arranged spaced apart from the head central axis, thereby forming a non-cutting zone in the vicinity of the head central axis and breaking off a uncut core of a work material generated in the non-cutting zone by press-contacting with an inclined step of the sinking portion. See Japanese Published Unexamined Patent Application Nos. 2003-25129 and 2003-236713.

However, the cutting head of the gun drill has a cross section of a two-thirds to three-quarters circle due to the cutting chip discharge groove on the outer circumference, and additionally, the coolant supply passages are provided inside. Thus, there is no room to form the afore-described throw away tip screw clamping structure within a cross sectional area of a thickness portion. In particular, the throw away tip has not been able to be applied when a tool diameter is small. Further, when a sinking portion is provided to the cutting blade side face and the inner end of the cutting blade is arranged spaced apart from the head central axis as in the afore-described throw away tip, there has been concern that the uncut core generated along the head central axis easily grows linearly to a position of contacting with the inclined step, whereupon a break-off size is enlarged and cutting chip discharge performance is reduced. Moreover, the cutting blade itself disadvantageously involves a great deal of trouble in processing and its manufacturing costs become expensive due to forming of the sinking portion on the side face and the inclined step.

### SUMMARY OF THE INVENTION

The present invention was made in view of the foregoing circumstances, and accordingly it is an object of the present invention to provide a gun drill particularly having a cutting blade of a single-edged blade in which high cutting efficiency can be achieved, and exact positional accuracy is not required when a cutting blade tip is brazed as the cutting blade, manufacturing of a cutting head is facilitated accordingly, and the cutting blade itself is also easily processed in terms of form.

Means for achieving the aforementioned object will be described with reference numerals of the accompanying drawings. A gun drill according to a first aspect of the present invention includes a tool shank 1 and a cutting head 2 mounted at a distal end portion of the tool shank 1. The cutting head 2 has a longitudinally extending head central axis O around which the cutting head rotates during drilling. Coolant supply passages 3a, 3b are provided inside the tool shank 1 and the cutting head 2, respectively, and communicate with one another. The gun drill includes a coolant discharge port 24 opened at the cutting head 2 and communicating with the coolant supply passages 3a, 3b, and a cutting chip discharge groove 4 formed on an outer circumferential surface extending lengthwise from a proximal side of the tool shank 1 to the cutting head distal end.

A cutting blade 5 of a single-edged blade is provided at the distal end of the cutting head 2 and borders the cutting chip discharge groove 4. The cutting blade 5 is such that a blade edge 51 thereof has an inner end 51a spaced apart from the head central axis O and forms a non-cutting zone Z in the vicinity of the head central axis O upon rotation of the gun drill during a drilling operation. As seen in FIG. 1, the inner end 51a of the blade edge 51 constitutes the forwardmost portion of the cutting head, and thus the drill. A cutting blade side face 52 at the inner end 51a side has an inclined surface which is inclined from the inner end 51a in a direction of the head central axis O. As the gun drill rotates during a drilling operation, the inclined cutting blade side face 52 press-contacts and breaks off an uncut core C of a work material W which is generated in the non-cutting zone Z.

A second aspect of the present invention is configured such that the cutting blade 5 has the cutting blade side face 52 at the inner end 51a side forming an angle of 75 to 90 degrees with respect to a cutting blade front face 53 in the gun drill of the first aspect as described above.

A third aspect of the present invention is configured such that the inner end 51a of the blade edge 51 is spaced 0.05 to 0.5 mm apart from the head central axis O and an inclination angle θ of the cutting blade side face 52 with respect to the head central axis O is 5 to 30 degrees in the gun drill of the first aspect as described above.

A fourth aspect of the present invention is configured such that the blade edge 51 of the cutting blade 5 is arranged parallel to radial line R passing through the head central axis O, and in a center-raised position 0.2 to 1.5 mm more forward in a cutting rotation direction than the radial line R in the gun drill of the first aspect as described above.

A fifth aspect of the present invention is configured such that the cutting blade 5 is composed of a cutting blade tip 50 brazed to a recessed portion 21a provided to the cutting head 2 in the gun drill of the first aspect as described above.

A sixth aspect of the present invention is configured such that a guide pad 6 is provided in a position on the opposite side of the cutting blade 5 side on an outer circumferential surface 2c of the cutting head 2 and the whole of the blade edge 51 of the cutting blade 5 is steeply and forwardly inclined toward the head central axis O side in the gun drill of any one of the first to the fifth aspects as described above.

Effects of the present invention will be described with reference numerals of the drawings. First, in the gun drill according to the first aspect of the present invention, the inner end 51a of the blade edge 51 of the cutting blade 5 is spaced apart from the head central axis O. Consequently, a non-cutting zone Z is formed in the vicinity of the head central axis O and a uncut core C of a work material W is generated in the non-cutting zone Z during deep-hole drilling work. However, the cutting blade side face 52 at the inner end 51a side of the blade edge 51 constitutes an inclined surface inclined from the inner end 51a to the head central axis O side. Therefore, the uncut core C is forcibly pushed away laterally by press-contact of the inclined cutting blade side face 52 and is broken off in such a manner as being twisted in line with rotation of the cutting head 2. Thus, the inclination of the cutting blade side face 52 increases the degree of lateral displacement from the head central axis O as the uncut core C becomes longer. As a result, the uncut core C is efficiently fragmented little by little without growing long, whereupon excellent cutting chip discharge performance is secured, and high cutting efficiency is attained in cooperation with an elimination of the chisel edge in the vicinity of the head central axis O. On the other hand, as for the cutting blade 5 itself, the cutting blade side face 52 thereof has only to be a simple inclined surface, so that its manufacturing can be carried out easily, and at a low cost.

According to the second aspect of the present invention, the cutting blade side face 52 at the inner end 51a side of the cutting blade 5 forms an angle in a specific range with respect to the cutting blade front face 53. Consequently, lateral displacement of the uncut core C by press-contact of the cutting blade side face 52 becomes larger, and fragmentation performance of the uncut core C is increased accordingly, while strength of a blade point at the inner end 51a side of the blade edge 51 is increased and the blade point is hard to chip, whereupon durability of the cutting blade 5 is improved.

According to the third aspect of the present invention, the inner end 51a of the blade edge 51 is spaced apart in a specific range from the head central axis O, and an inclination angle θ of the cutting blade side face 52 with respect to the head central axis O is in a specific range. Consequently, the uncut core C is reliably broken off little by little at an appropriate diameter.

According to the fourth aspect of the present invention, the blade edge 51 of the cutting blade 5 is arranged in an appropriate center-raised position, so that the little by little break-off of the uncut core C is carried out more reliably.

According to the fifth aspect of the present invention, the cutting blade 5 is composed of the cutting blade tip 50 brazed to the recessed portion 21a provided to the cutting head 2, but the blade edge 51 of the cutting blade 5 does not need to be made in agreement with the radial line R passing through the head central axis O. Additionally, the inner end 51a of the blade edge 51 has only to be spaced apart appropriately from the head central axis O, too. Therefore, exact positional accuracy at the time of brazing the cutting blade tip 50 is not required, and the manufacturing of the cutting head 2 is facilitated accordingly.

According to the sixth aspect of the present invention, a guide pad 6 is provided in a position on the opposite side of the cutting blade 5 side on the outer circumferential surface 2c of the cutting head 2, and the whole of the blade edge 51 of the cutting blade 5 is steeply and forwardly inclined toward the head central axis O side, so that the radial force of the cutting reaction force is directed to the opposite side of the cutting blade 5 side and acts in such a manner as pressing the guide pad 6 on the opposite side of the cutting blade 5 against an inner circumference of the cutting hole H. Thus, drilling accuracy of the cutting hole H is improved.

### BRIEF DESCRIPTION OF THE DRAWINGS

FIG. 1 shows a cutting head side of a gun drill according to one embodiment of the present invention, and FIG. 1A is a front view and FIG. 1B is a side view;

FIG. 2 is a side view of the cutting head side of the gun drill viewed from a different direction;

FIG. 3 is a longitudinal cross-sectional front view showing a state of deep-hole drilling work by the gun drill;

FIG. 4 is a longitudinal cross-sectional side view showing a behavior of a cutting central portion in the deep-hole drilling work;

FIG. 5 is a plan view showing the behavior of the cutting central portion;

FIG. 6 shows a configuration example of a conventional gun drill, and FIG. 6A is a side view of the whole, FIG. 6B is a cross-sectional view taken along arrow B-B in FIG. 6A, and FIG. 6C is a cross-sectional view taken along arrow C-C in FIG. 6A; and

FIG. 7 shows a cutting head side of the conventional gun drill in an enlarged manner,

FIG. 7A is a side view and FIG. 7B is a front view.

### DESCRIPTION OF REFERENCE NUMERALS

1: Tool shank
2: Cutting head
2b: Distal end surface
2c: Outer circumferential surface
20: Head main body
21a: Recessed portion
23: Coolant lead-out port
24: Coolant discharge port
3a, 3b: Coolant supply passage
4: Cutting chip discharge groove
5: Cutting blade
50: Cutting blade tip
51: Blade edge
51a: Inner end
52: Cutting blade side face
53: Cutting blade front face
6: Guide pad
H: Cutting hole
O: Head central axis
R: Radial line
Z: Non-cutting zone
θ: Inclination angle
f: Distance (center-raised amount)
s: Distance (eccentric distance)

### DETAILED DESCRIPTION

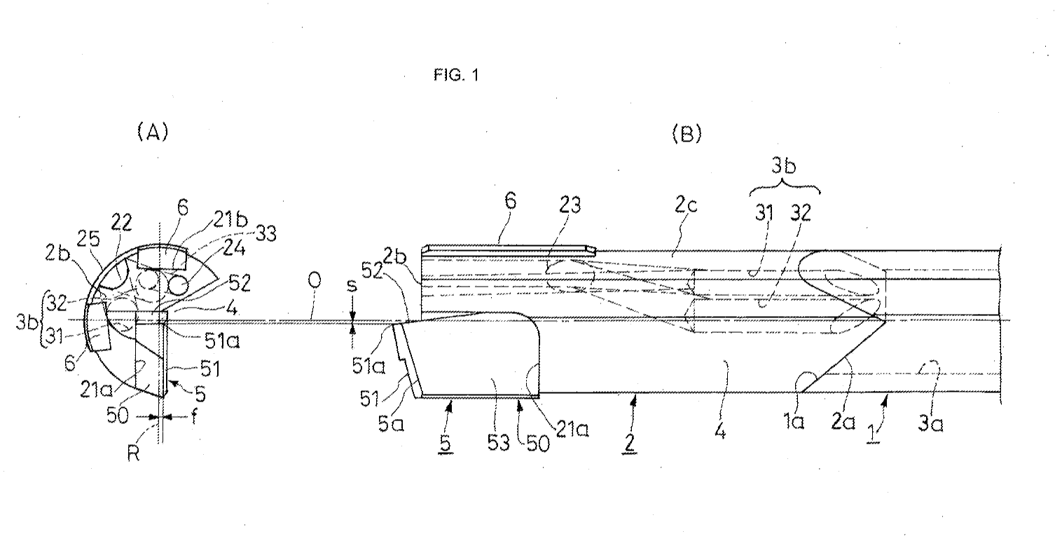

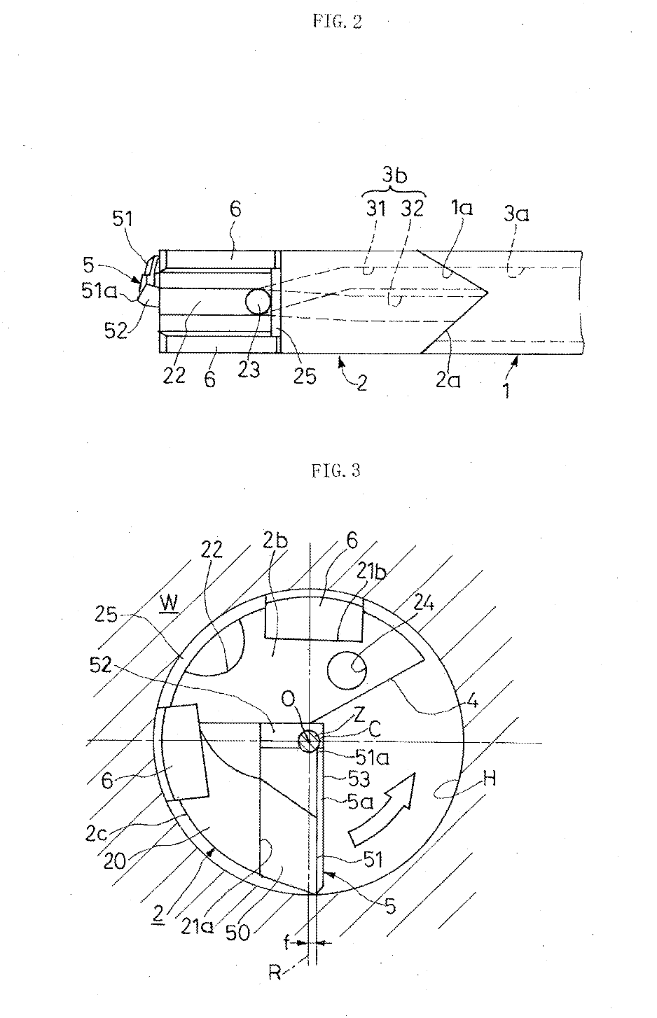

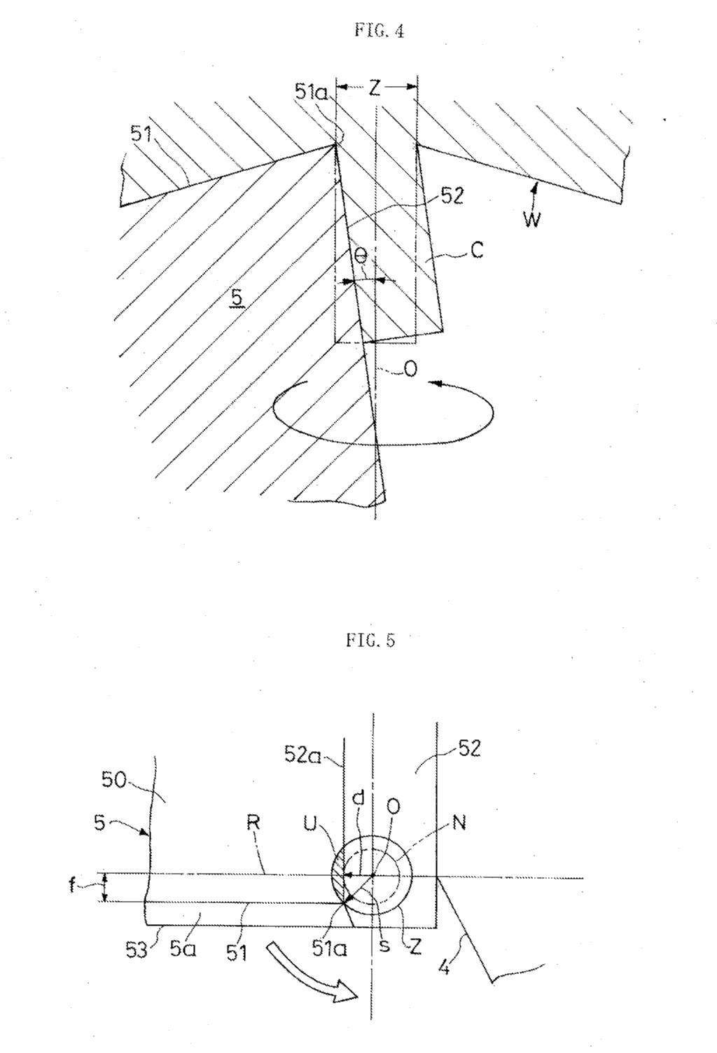

Hereinafter, an embodiment of a gun drill according to the present invention will be described in detail with reference to the drawings. FIG. 1 shows a side and a front of a cutting head side of a gun drill of the embodiment, FIG. 2 shows a side of the cutting head side of the gun drill viewed from a different direction, FIG. 3 shows a state of deep-hole drilling work by the gun drill, and FIG. 4 and FIG. 5 show a behavior of a cutting central portion in the deep-hole drilling work, respectively.

As shown in FIG. 1, a gun drill of this embodiment is composed of an elongated tool shank 1 made of a pipe material such as steel and having a distal end 1a cut in a V-shape, a cutting head 2 having a proximal end 2a cut in a corresponding inverted V-shape (mountain-shape) and brazed to the distal end 1a to be concentrically coupled. The gun drill also includes one linear cutting chip discharge groove 4 on an outer circumferential surface extending lengthwise from a proximal side of the tool shank 1 to a distal end of the cutting head 2. The cutting chip discharge groove 4 forms a V-shape in cross section whose opening angle from the center of the tool shank 1 and the cutting head 2 is approximately 110 to 130 degrees.

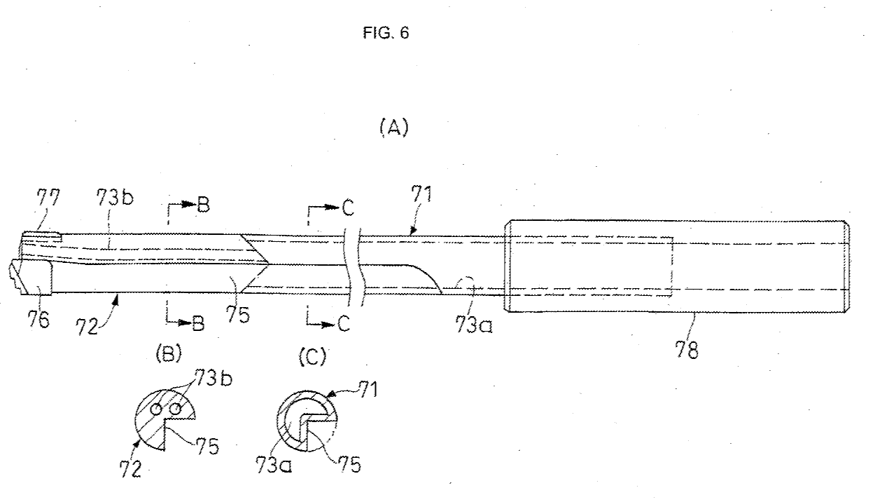

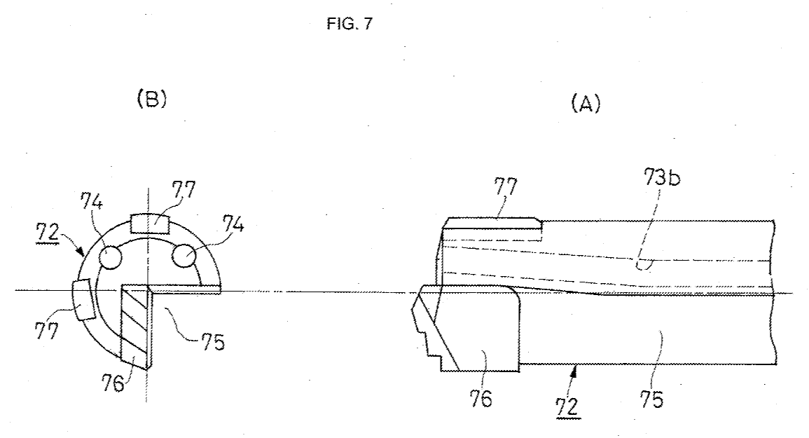

The tool shank 1 is formed by die-forming the pipe material so as to have a cross section of a two-thirds circle except for a proximal end portion side to form the cutting chip discharge groove 4 at an outer surface side. An interior space thereof constitutes a coolant supply passage 3a. Although illustration is omitted, the proximal end portion of the tool shank 1 is inserted, fitted and fixed to a large-diameter cylindrical driver in the same manner as the conventional configuration (see FIG. 6).

As shown in FIGS. 1 to 3, the cutting head 2 is formed with a cutting blade 5 of a single-edged blade bordering the cutting chip discharge groove 4 by fixing a thick-plate cutting blade tip 50, at a distal end side of a head main body 20 assuming a two-thirds circle in cross section corresponding to the tool shank 1. The cutting head 2 is also fixed with axially long semicylindrical guide pads 6 on a radially opposite side of the cutting blade 5 side on an outer circumferential surface 2c and on a back side of the cutting blade 5. In addition, the cutting blade tip 50 and the guide pad 6 are formed of a hard material such as cemented carbide, sintered ceramics, cermet, etc., fitted into recessed portions 21a, 21b provided in advance to the head main body 20 made of steel such as tool steel, and brazed by a metalizing method. Thus, in the embodiment shown, the blade tip 50 and the guide pad 6 are devoid of clamping bores suitable for receiving a clamping screw.

Further, two coolant circulation holes 31, 32 are formed in the interior extending from a proximal end 2a of the cutting head 2 to a lengthwise direction intermediate portion as a coolant supply passage 3b communicating with the coolant supply passage 3a of the tool shank 1. A cross-sectionally substantially semicircular coolant lead-out groove 22 extending from the lengthwise direction intermediate portion to a head distal end surface 2b is formed on the outer circumferential surface 2c at the back side relative to the cutting chip discharge groove 4 while situated between both guide pads 6. Both coolant circulation holes 31, 32 join and communicate with a coolant lead-out port 23 being open at the proximal end side of the coolant lead-out groove 22. Further, as shown in FIG. 1A, a coolant discharge port 24 located in the vicinity of an edge on the opposite side of the cutting blade 5 side of the cutting chip discharge groove 4 and communicated with one of the coolant circulation holes 32 via a small-diameter circulation hole 33 is opened at the distal end surface 2b of the cutting head 2. Furthermore, a backflow preventing protrusion 25 along a circumferential direction extending between both guide pads 6 is formed at the rear side of the coolant lead-out port 23.

The cutting blade 5 has a blade edge 51 that is steeply and forwardly inclined toward the head central axis O side and is two-step shaped. A stepped chip breaker 5a is provided along the blade edge 51 at the front face side. An inner end 51a of the blade edge 51 constitutes the forwardmost portion of the cutting head 2, and thus the drill. The inner end 51a is arranged so as to be apart by a distance s from the head central axis O in a position where the blade edge 51 is parallel to a radial line R about the head central axis O and also a center thereof is raised by a distance f more forward in the cutting rotation direction than the radial line R. Further, a cutting blade side face 52 at the inner end 51a side of this cutting blade 5 constitutes an inclined surface which is inclined from the inner end 51a to the head central axis O side, and the surface orientation is configured at a right angle to a cutting blade front side 53.

In deep-hole drilling work by the above-described gun drill, the coolant supplied through the coolant supply passages 3a, 3b within the tool shank 1 and the cutting head 2 is sent into the cutting region continuously while the gun drill or the work material W is rotated. The coolant catches cutting chips generated in the cutting region and discharges the cutting chips outside through the cutting chip discharge groove 4. Therefore, in this embodiment, the coolant is led out mainly from the coolant lead-out port 23 provided on the outer circumferential surface 2c of the cutting head 2 to the coolant lead-out groove 22, through which the coolant is discharged to the cutting region. A residual part of the coolant passes from one of the coolant circulation holes 32 through the circulation hole 33 and is discharged from the coolant discharge port 24 at the head distal end surface 2b to the cutting region.

As described above, the inner end 51a of the blade edge 51 of the cutting blade 5 is spaced apart from the head central axis O in this gun drill, whereby a circular non-cutting zone Z whose radius is an eccentric distance s is formed in the vicinity of the head central axis O, as shown in FIG. 3, and a uncut core C of a work material W is generated in this non-cutting zone Z. The cutting blade side face 52 at the inner end 51a side of the blade edge 51 forms an inclined surface which is inclined from the inner end 51a to the head central axis O side, the head central axis being shown in FIG. 4 to intersect the cutting blade side face 52. Because of this, the uncut core C is forcibly pushed away laterally by press-contact of the inclined cutting blade side face 52 as shown by a virtual line, and is broken off in such a manner as being twisted in line with rotation of the cutting head. As seen in FIG. 4, the inclination of the cutting blade side face 52 increases the degree of lateral displacement from the head central axis O as the uncut core C becomes longer. Therefore, the uncut core C is efficiently fragmented little by little without growing long, whereupon excellent cutting chip discharge performance is secured, and high cutting efficiency is attained in cooperation with an elimination of the chisel edge at the head central axis.

Furthermore, in this embodiment, the blade edge 51 of the cutting blade 5 is arranged in a center-raised position by a distance f more forward than the radial line R about the head central axis O, and the cutting blade side face 52 at the inner end 51a side is perpendicular to the cutting blade front face 53. Consequently, as shown in FIG. 5, an upper end edge 52a on the cutting blade side face 52 continuing from the inner end 51a of the blade edge 51 to the rearward comes to enter into the non-cutting zone Z by the shaded portion U as shown since the shortest distance d with respect to the head central axis O becomes shorter than the eccentric distance s of the inner end 51a of the blade edge 51. Therefore, the uncut core C generated by the cutting by the blade edge 51 is pushed and cut from the lateral side by the shaded portion U soon after the generation, and is constricted to a circle N having a smaller radius d than the non-cutting zone Z. As a result, the uncut core C is further easily broken off little by little. Further, the whole of the blade edge 51 of the cutting blade 5 is steeply and forwardly inclined toward the head central axis O side, so that the radial force of the cutting reaction force is directed to the opposite side of the cutting blade 5 side and acts in such a manner as pressing the guide pad 6 on the opposite side of the cutting blade 5 against an inner circumference of the cutting hole H. Thus, there is also an advantage of improving drilling accuracy of the cutting hole H.

In this gun drill, on the other hand, the cutting blade 5 is composed of the cutting blade tip 50 brazed to the recessed portion 21a provided to the cutting head 2, but the blade edge 51 of the cutting blade 5 does not need to be made in agreement with the radial line R passing through the head central axis O. Additionally, the inner end 51a of the blade edge 51 also has only to be spaced apart from the head central axis O appropriately, so that exact positional accuracy is not required at the time of brazing the cutting blade tip 50, which facilitates the manufacturing of the cutting head 2 accordingly. Further, as for the cutting blade tip 50 itself as well, the cutting blade side face 52 thereof has only to be a simple inclined surface, so that its manufacturing can be carried out easily at a low cost. It is noted that the gun drill of the present invention includes one in which the cutting blade 5 is integrally formed with the head main body 20, too.

An inclination angle θ of the cutting blade side face 52 at the inner end 51a side of the cutting blade 5 with respect to the head central axis O is preferably in the range of 5 to 30 degrees. If the inclination angle θ is too small or too large, break-off performance (fragmentation performance) of the uncut core C becomes low. Further, the eccentric distance s of the inner end 51a of the blade edge 51 from the head central axis O is preferably in the range of 0.05 to 0.5 mm. If too short, positioning at the time of brazing the cutting blade tip 50 becomes difficult, whereas if too long, the uncut core C becomes thick, which requires a large force for break-off and leads to a reduction in cutting efficiency. Furthermore, a center-raised amount of the cutting blade 5, in other words, a distance f of the blade edge 51 with respect to the radial line R about the head central axis O is preferably in the range of 0.2 to 1.5 mm for the purpose of further ensuring the little by little break-off of the uncut core C.

Furthermore, the cutting blade side face 52 at the inner end 51a side of the cutting blade 5 is perpendicular to the cutting blade front face 53 in the afore-described embodiment. However, the cutting blade side face 52 has only to be in the angle range of 75 to 90 degrees with respect to the cutting blade front face 53 in the present invention. In this angle range, the lateral displacement of the uncut core C by press-contact of the cutting blade side face 52 becomes sufficiently large and fragmentation performance of the uncut core C is increased accordingly, while strength of a blade point at the inner end 51a side of the blade edge 51 is increased, so that the blade point is hard to chip, whereupon durability of the cutting blade 5 is improved.

Further, as in the gun drill of this embodiment, the cutting blade tip 50 and two guide pads 6 are brazed to the distal end side of the cutting head 2, and additionally, the opening angle of the V-shape in cross section of the cutting chip discharge groove 4 is set at 110 to 130 degrees, which is large, thereby resulting in the cross section of the thickness portion of the distal end side of the head main body 20 becoming small. As a result, the hole diameter of the inner coolant passage cannot be made large. However, if the inner coolant supply passage 3a at the head proximal end side is made to communicate with the coolant lead-out groove 22 at the outer circumferential surface side, at the head-lengthwise direction intermediate portion, and the passage cross-sectional area to the cutting region is secured large by this coolant lead-out groove 22, a sufficient amount of coolant can be supplied to the cutting region. Thus, in this embodiment, the large coolant supply amount to the cutting region is combined with the large passage cross-sectional area of the cutting chip discharge groove 4 side, whereupon excellent cutting chip discharge performance can be attained and cutting efficiency of deep-hole drilling work can be improved significantly. The backflow preventing protrusion 25 at the rear side of the coolant lead-out port 23 prevents the coolant from flowing back rearward from a gap between an inner circumference of the cutting hole H and an outer circumference of the cutting head 2, thereupon performing a function of improving coolant supply efficiency.

As described above, discharge of cutting chips is further promoted by providing the coolant discharge port 24 to the distal end surface 2b of the cutting head 2 in the gun drill of this embodiment. However, the coolant discharge port 24 at the head distal end surface 2b is not essential in the gun drill of the present invention, and is preferably omitted for securing strength of the cutting head especially when a tool diameter is small. Further, in the present invention, the upper end edge 52a on the cutting blade side face 52 at the inner end side of the cutting blade 5 enters into the non-cutting zone Z, as shown in FIG. 5, which is effective in easily breaking off the uncut core C further little by little as already described. However, in order to avoid an increase in cutting resistance due to push-cutting at the upper end edge 52a, the upper end edge 52a on the cutting blade side face 52 may be made round-shaped including the inner end 51a of the blade edge 51, and the entering portion (shaded portion U in FIG. 5) may not be generated. Besides, detailed configurations such as the shape of the cutting blade 5 and the cutting blade tip 50, the shape of the guide pad 6, etc., can be modified in various ways except for the embodiment in the present invention.

What is claimed is:

1. A gun drill comprising:
a tool shank;
a cutting head mounted on a distal end portion of the tool shank, the cutting head having a longitudinally extending head central axis (O) around which the cutting head rotates;
a coolant supply passage provided inside the tool shank and a coolant supply passage provided inside the cutting head, the two coolant supply passages communicating with one another;
a coolant discharge port opened at the cutting head and communicating with the coolant supply passage provided inside the cutting head;
a cutting chip discharge groove provided on an outer circumferential surface and extending lengthwise from a proximal side of the tool shank to a cutting head distal end; and
a cutting blade provided at the cutting head distal end and bordering the cutting chip discharge groove, wherein the cutting blade comprises:
a blade edge having an inner end spaced apart from the head central axis of the cutting head, whereby the inner end forms a non-cutting zone in the vicinity of the head central axis upon rotation of the gun drill during drilling operations, and
a cutting blade side face at an inner end side of the cutting blade, the cutting blade side face having an inclined surface which is inclined from the inner end to the head central axis side,
wherein the inclined surface of the cutting blade side face is configured to press-contact and break off an uncut core generated in the non-cutting zone upon rotation of the gun drill during drilling operations.

2. The gun drill according to claim 1, wherein:
the cutting blade side face forms an angle of 75 to 90 degrees with respect to a cutting blade front face.

3. The gun drill according to claim 1, wherein:
the inner end of the blade edge is spaced 0.05 to 0.5 mm apart from the head central axis; and
an inclination angle of the cutting blade side face with respect to the head central axis is 5 to 30 degrees.

4. The gun drill according to claim 1, wherein the blade edge of the cutting blade is arranged parallel to radial line (R) passing through the head central axis, and in a center-raised position 0.2 to 1.5 mm more forward in a cutting rotation direction than the radial line.

5. The gun drill according to claim 1, wherein:
the cutting blade comprises a cutting blade tip brazed to a recessed portion of the cutting head.

6. The gun drill according to claim 1, wherein:
a guide pad is provided on an outer circumferential surface of the cutting head at a position opposite to the cutting blade; and
an entire blade edge of the cutting blade is steeply and forwardly inclined toward the head central axis side.

7. The gun drill according to claim 1, wherein:
an entire blade edge of the cutting blade is forwardly inclined toward the head central axis side.

8. The gun drill according to claim 1, wherein:
the inner end constitutes the forwardmost portion of the cutting head.

9. The gun drill according to claim 1, wherein:
the head central axis intersects the inclined surface of the cutting blade side face.

10. The gun drill according to claim 1, wherein:
the cutting blade is a single-edged blade.

11. The gun drill according to claim 1, wherein:
an entire blade edge of the cutting blade is forwardly inclined toward the head central axis side;
the inner end constitutes the forwardmost portion of the cutting head;
the head central axis intersects the inclined surface of the cutting blade side face; and
the cutting blade is a single-edged blade.

12. The gun drill according to claim 11, wherein:
a guide pad is brazed onto an outer circumferential surface of the cutting head at a position opposite to the cutting blade; and
the cutting blade comprises a cutting blade tip brazed to a recessed portion of the cutting head; and
the cutting blade tip and the guide pad are devoid of clamping bores suitable for receiving a clamping screw.

13. A method for cutting a workpiece, comprising:
providing a gun drill comprising:
a tool shank;
a cutting head mounted on a distal end portion of the tool shank, the cutting head having a longitudinally extending head central axis (O) around which the cutting head rotates;
a coolant supply passage provided inside the tool shank and a coolant supply passage provided inside the cutting head, the two coolant supply passages communicating with one another;
a coolant discharge port opened at the cutting head and communicating with the coolant supply passage provided inside the cutting head;
a cutting chip discharge groove provided on an outer circumferential surface and extending lengthwise from a proximal side of the tool shank to a cutting head distal end; and
a cutting blade provided at the cutting head distal end and bordering the cutting chip discharge groove, wherein the cutting blade comprises:
a blade edge having an inner end spaced apart from the head central axis of the cutting head, whereby the inner end forms a non-cutting zone in the vicinity of the head central axis upon rotation of the gun drill during drilling operations, and
a cutting blade side face at an inner end side of the cutting blade, the cutting blade side face having an inclined surface which is inclined from the inner end to the head central axis side, and
drilling the workpiece to thereby form a hole having an uncut core in the non-cutting zone;
wherein the inclined surface of the cutting blade side face press-contacts and breaks off the uncut core upon rotation of the gun drill during drilling operations.

14. The method according to claim 13, comprising fragmenting the uncut core little by little.

15. The method according to claim 13, wherein the blade edge does not contact the uncut core, during drilling operations.

16. A gun drill comprising:
a tool shank;
a cutting head mounted on a distal end portion of the tool shank, the cutting head having a longitudinally extending head central axis (O) around which the cutting head rotates;
a coolant supply passage provided inside the tool shank and a coolant supply passage provided inside the cutting head, the two coolant supply passages communicating with one another;
a coolant discharge port opened at the cutting head and communicating with the coolant supply passage provided inside the cutting head;
a cutting chip discharge groove provided on an outer circumferential surface and extending lengthwise from a proximal side of the tool shank to a cutting head distal end; and
a cutting blade provided at the cutting head distal end and bordering the cutting chip discharge groove, wherein the cutting blade comprises:
a single blade edge having an inner end spaced apart from the head central axis of the cutting head, and
a cutting blade side face at an inner end side of the cutting blade, the cutting blade side face having an inclined surface which is inclined from the inner end to the head central axis side,
and wherein:
an entire blade edge of the cutting blade is forwardly inclined toward the head central axis;
the inner end constitutes the forwardmost portion of the cutting head; and
the head central axis intersects the inclined surface of the cutting blade side face.
